(19) United States
(12) Patent Application Publication
(10) Pub. No.: US 2005/0030374 A1
(43) Pub. Date: Feb. 10, 2005

(54) Recording and quality management solutions for walk-in environments

(76) Inventors: Yoel Goldenberg, Ramat Haaharon (IL); Ilan Freedman, Petach Tikva (IL)

Correspondence Address: HOGAN & HARTSON LLP;IP GROUP, COLUMBIA SQUARE, 555 THIRTEENTH STREET, N.W., WASHINGTON, DC, 20004, US

(21) Appl. No.: 10/488,686

(22) PCT Filed: Sep. 5, 2002
(86) PCT No.: PCT/IL02/00741

Related U.S. Application Data
(60) Provisional application No. 60/317,150, filed on Sep. 6, 2001.

(51) Int. Cl. H04N 9/47

(52) U.S. Cl. 348/143

(57) ABSTRACT

A system and methods for capturing, storing and retrieving customer face-to-face frontal interactions characterizing walk-in environments, for the purpose of quality management. The system comprises interaction capture and storage unit, which includes at least one of screen capture, storage and retrieval component or, voice capture, storage and retrieval component or, video capture, storage and retrieval component. The system comprising a set of recording and information gethering technics suitable for Walk-in environments that will enable organizations to record retrieve and evaluate the frontal interactions with their customers.

### RELATED APPLICATIONS

The present invention relates and claims priority from U.S. provisional patent application Ser. No. 60/317,150 titled QUALITY MANAGEMENT AND RECORDING SOLUTIONS FOR WALK-IN CENTERS, filed 6 Sep. 2001.

The present invention relates to PCT patent application serial number PCT/IL02/00197 titled A METHOD FOR CAPTURING, ANALYZING AND RECORDING THE CUSTOMER SERVICE REPRESENTATIVE ACTIVITIES filed 12 Mar., 2002, and to PCT patent application serial number PCT/IL02/00796 titled SYSTEM AND METHOD FOR CAPTURING BROWSER SESSIONS AND USER ACTIONS filed 24 Aug., 2001, and to U.S. patent application Ser. No. 10/056,049 titled VIDEO AND AUDIO CONTENT ANALYSIS SYSTEM filed 30 Jan. 2001, and to U.S. provisional patent application Ser. No. 60/354,209 titled ALARM SYSTEM BASED ON VIDEO ANALYSIS filed 6 Feb. 2002, and to PCT patent application serial number PCT/IL02/00593 titled METHOD, APPARATUS AND SYSTEM FOR CAPTURING AND ANALYZING INTERACTION BASED CONTENT filed 18 Jul. 2002, the content of which is hereby incorporated by reference.

### BACKGROUND OF THE INVENTION

1. Field of the Invention

The present invention relates to capturing, storing and retrieval of synchronized voice, screen and video interactions, in general and to methods for triggering of recording, to Customer Experience Management (CEM) and interactions capturing for quality management (QM) purposes, in particular.

2. Discussion of Related Art

A major portion of the interaction between a modern business and its customers are conducted via the Call Center or Contact Center. These somewhat overlapping terms relate to a business unit which manages and maintains interactions with the business' customers and prospects, whether via means of phone in the case of the Call Center and/or through computer-based media such as e-mail, web chat, collaborative browsing, shared whiteboards, Voice over IP (VOIP), etc. These electronic media have transformed the Call Center into a Contact Center handling not only traditional phone calls, but also a complete multimedia contacts.

Digital voice, data and sometimes screen recording is common practice in Call Centers and Contact Centers as well as in trading floors and in bank branches. Such recording abilities are typically used for compliance purposes, when such recording of the interactions is required by law or other means of regulation, risk management, limiting the businesses' legal exposure due to false allegations regarding the content of the interaction or for quality assurance using the re-creation of the interaction to evaluate an agent's performance.

Current systems are focused on recording phone calls such as Voice, VoIP and computer based interactions with customers such as e-mails, chat sessions, collaborative browsing and the like, but are failing to address the recording of the most common interactions, the ones done in walk-in environments where the customer has a frontal, face-to-face, interaction with the company representative. This solution is referring to any kind of frontal, face to face point of sale or service from service centers through branch banks, fast food counters and the like.

As mentioned earlier there is no current solution for recording, for quality management purposes and for content related business analytics, of the most common interactions—the ones done in a walk-in environment such as walk-in centers, branch banks, stores and many other private, commercial or government points of presence, where a person has a frontal interaction with an agent. This is referring to any kind of service-providing center. Non-limiting examples are service centers, fast food counters, check-in counter, any Over The Counter (OTC) face-to-face provided services and the like. Defining an agent to be any professional representative of a business or government providing a service to a customer or civilian. Non limiting examples would include: a clerk in a store, a banker, a tax authority representative servicing representatives at IRS offices, a ground agent checking a passenger in for a flight and the like.

The problem that the current known in the art solutions are faced with is a conceptual one as well as a technological one. The basis for a recording of an interaction includes an identified beginning and end. Phone call, email handling and web collaboration sessions all have a defined beginning and end that can be identified easily. Furthermore, most technological logging platforms enable the capturing of interactions and thus are able to provide additional information about the interaction. In frontal center there are no means of reporting of beginning and end of interactions, nor the ability to gain additional information about the interaction that would enable one to associate this “additional information” to it and to act on it. In referring to “additional information” we refer to information such as who the customer (or civilian) is, how long he or she has been waiting in line to be served, what service the customer intended to discuss when reaching the agent and so on and so forth. Information like this is readily available and commonly used in recording phone calls and can be obtained by CTI (Computer Telephony Integration) information or CDR/SMDR (Call Detail Reporting/Station Message Details Recording) connectivity. For email and other media this has been achieved by integrating the enabling platform, using a proprietary protocol of some sort with the recording platform. By virtue, the walk-in environment's characteristic is of people seeking service that come and leave according to the queue and there is no enabling platform for the communication.

Another problem is how to record such interactions since there is no line of communication between both sides. Additional aspect of the problem is the fact that the interaction in a walk-in environment has a visual aspect, which does not typically exist in remote communications discussed above. The visual, face-to-face interaction between agents and customers (or civilians) is important in this environment and therefore should be recorded too.

The present solution deals with the described problems by solving the obstacles presented, providing a method for face-to-face recording, storing and retrieval, organization will be able to provide abilities as to enforce quality management, exercise business analytic techniques and as direct consequence enhance quality of services in its remote branches.

The person skilled in the art will appreciate that there is therefore a need for a simple new and novel method for capturing and analyzing Walk-in, face-to-face interaction for quality management purposes.

### SUMMARY OF THE PRESENT INVENTION

It is an object of the present invention to provide a novel method and system for capturing, logging and retrieval of face-to-face (frontal) interactions for the purpose of further analysis, by overcoming known technological obstacles characterizing the commonly known “Walk-in” environments.

In accordance with the present invention, there is thus provided a system for capturing face-to-face interaction comprising interaction capturing and storage unit, microphones (wired or wireless) devices located near the parties interacting and optionally one (or more) video camera. The system interaction capture and storage unit further comprises of at least a voice capture, storage and retrieval component and optionally a screen capture and storage component for screen shot and screen events interaction capturing, storing and retrieval, video capture and storage component for capturing, storing and retrieval of the visual streaming video interaction. In addition a database component in which information regarding the interaction is stored for later analysis is required, non-limiting example is interaction information to be evaluated by team leaders and supervisors. The database holds additional metadata related to the interaction and any information gathered from external source, non-limiting example is information gathered from a 3^{rd} party such as from Customer Relationship Management (CRM) application, Queue Management System, Work Force Management Application and the like. The database component can be an SQL database with drivers used to gather this data from surrounding databases and components and insert this data into the database.

In accordance with the present invention a variation system would be a system in which the capture and storage elements are separated and interconnected over a LAN/WAN or any other IP based network. In such an implementation the capture component is located at the location at which the interaction takes place. The storage component can either be located at the same location or be centralized at another location covering multiple walk-in environments (branches). The transfer of content (voice, screen or other media) from the capture component to the storage component can either be based on proprietary protocols such as but not limiting to a unique packaging of RTP packets for the voice or based on standard protocols such as H.323 for VoIP.

In accordance with the present invention, there is also provided a method for collecting or generating information in a CTI less or CDR feed less “walk-in” environment for separating the media stream into interactions representing independent customer interactions and for generating additional data known as metadata describing the call. The metadata typically, provides additional data to describe the interactions entry in the database of recorded interactions enabling fast location of a specific interaction and to derive recording decisions and flagging of interactions based on this data (non limiting example is a random or rule based selection of interaction to be recorded or flagged for the purpose of quality management).

### DETAILED DESCRIPTION OF THE PREFERRED EMBODIMENT

The present invention disclosed a new methods and system for capturing, storing, retrieving face-to-face interactions for the purpose of quality management in Walk-in environment.

The proposed solution is a set of recording and information gethering technics, creating a system solution for Walk-in Environments that will enable organizations to record retrieve and evaluate the frontal interactions with their customers. Such face-to-face interactions might be interactions that customers experience on a daily bases such as in fast food counters, banking, point of sale and the like as well as those interactions that are the more complicated to handle, cases were customers like in the case of service centers come physically to the supplier of the service once they “gave up” on other means of communication.

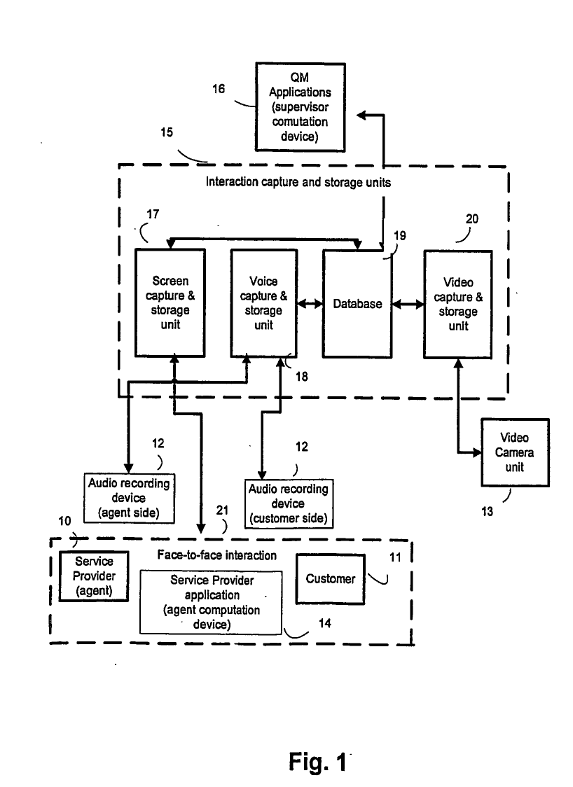

The present invention will be understood and appreciated from the following detailed description taken in conjunction with the drawing of FIG. 1. In FIG. 1 a typical high-level diagram solution for walk-in centers is shown. The system 1 describes a process flow, starting from the face-to-face interaction between parties and ending in an application that benefits from all the recorded, processed and analyzed information. The agent 10 and the customer 11 are representing the parties engaged in the interaction 21, interaction 21 is candidate for further capture and evaluation. Interaction 21 in the context of the present embodiment is any stream of information exchanged between the parties during face-to-face communication session whether voice captured by microphones, computer information captured by screen shots from the agent's workstation or visual gestures captured by video from cameras. The system includes interaction capture and storage unit 15 which includes at least one voice capture and storage component 18 for voice interaction capturing, storing and retrieval as a non-limiting example NiceLog by NICE Systems Ltd. of R'annana, Israel, and optionally one or more screen capture and storage components 17 for screen shot and screen events interaction capturing, storing and retrieval such as a non limiting example NiceScreen by NICE Systems Ltd. of Raanana, Israel, one or more video capture and storage component 20 for capturing, storing and retrieval of the visual streaming video interaction coming from one, or more, video camera 13, a non-limiting example such as NiceVision by NICE Systems Ltd., and a database component 19 in which information regarding the interaction is stored for later query and analysis as non limiting example NicCLS by NICE Systems Ltd. of Raanana, Israel. A variant or alternative solution for the purpose of branch recording is where the capture and storage elements are separated and interconnected over a LAN/WAN or any other IP based local or wide or other network. In such an implementation the capture component is located at the location at which the interaction takes place. The storage component, which includes the database component 19, can either be located at the same location or be centralized at another location covering multiple walk-in environments or branches. The transfer of content voice, screen or other media from the capture component to the storage component can either be based on proprietary protocols such as a unique packaging of RTP packets for the voice or based on standard protocols such as H.323 for VoIP and the like.

In order to capture the voice, two 12 omni-directional microphones are installed directed at both side of the interaction, agent 10, customer 11. Alternately, a single bi-directional microphone may be used. Once captured voice, screen and video recordings are stored in an Interaction capture & storage unit 15, the information is stored in a database 19 and may either be recreated for purposes such as dispute resolution or be further evaluated by team leaders and supervisors 16 using for example by the NiceUniverse application suite by NICE Systems Ltd. of Raanana, Israel. The suggested solution enables capturing of the interaction with microphones 12 and video cameras 13 located in the walk-in service center. It should be noted that the video 20, voice 18 and the screen 17 capture & storage components are synchronized by continuously synchronizing their clocks using any time synchronization method for example by using as a non limiting example the NTP—Network Time Protocol or IRIG-B.

One of the major challenges in a walk-in face-to-face interaction environment is the lack of the CTI or CDR feed. This is limiting not only since it is needed to separate the stream into interactions representing independent customer interactions but also since the data describing the call is required for other uses. This data, referred to as metadata can include the agents name or specific ID, the customer name or specific ID, an account number, the department or service the interaction is related to, various flags such as to indicate if a transaction was completed or if the case has been closed in addition to the beginning and end time of the interaction. This is the type of information one usually receives from the CTI link in telephony centric interaction but is not available in this environment due to the fact that an interaction-enabling platform, such as telephony switch, is not required.

The metadata is typically used for three uses: firstly to determine the beginning and end of the interaction, secondly to provide additional data to describe the interactions entry in the database of recorded interactions for enabling fast location of a specific interaction and thirdly, to drive recording decisions and flagging of interactions based on this data.

Here are solutions offered to overcome these three obstacles, regarding the determination of beginning and end of recording. The use of (a) what can be defined as “Block Of Time” recording, were time intervals are predefined for the Interaction capture and storage unit 15 to record all interactions taking place at that particular time periods. (b) Screen event driven recording can define the start or end of recording based on an event/action made in the application running on the agent's desktop which is typical or representative of the start or end of an interaction or of a part or interaction which is of interest Non-limiting examples are launching of a new customer screen in the CRM application, agent opening a new customer file, or inviting next customer in line by clicking on the “Next” button in the queue management system application, or whenever a discount of more then $100 is entered into a CRM application's designated data field, or whenever a specific screen is loaded then start recording. Screen activity is captured by screen capture and storage component 17. The screen event capturing agent action is fully described in co-pending PCT patent application serial number PCT/IL02/00197 titled A METHOD FOR CAPTURING, ANALYZING AND RECORDING THE CUSTOMER SERVICE REPRESENTATIVE ACTIVITIES filed 12 Mar., 2002, and in PCT patent application serial number PCT/IL02/00796 titled SYSTEM AND METHOD FOR CAPTURING BROWSER SESSIONS AND USER ACTIONS filed 24 Aug., 2001 both are incorporated herein by reference. Furthermore, by correlating the screen events with voice content analysis one can reach a higher level of accuracy for example by identifying the end of the interaction by the agent saying “next” and at a near time closing the customer's file in the CRM application. (c) Selective recording based on real time video content analysis is another solution for determining start and stop sessions as well as the complete identification of the parties interacted. An example of using face recognition algorithm is explained in detail in VIDEO AND AUDIO CONTENT ANALYSIS SYSTEM, which is incorporated herein by reference, detailed of application stated below. Algorithm running for example on NICE propriety hardware/firmware DSP's based boards or on (OTS) Off-The-Shelf board uploaded with known in the art other face recognition algorithms. As mentioned earlier the video, agent screen and voice are time synchronized and as such the start and end of interaction is deterministic. Frame presence detection defines a video frame to trigger recording whenever a person is detected (co-exist) for more then x seconds, when video frame empty then stop recording (similar to energy level detection in Voice recording). Frame content manipulations are inherent in NICE VISION Product of NICE Systems Ltd. Example of capabilities of object/people video content-based detection can be found in co-pending U.S. provisional patent application Ser. No. 60/354,209 titled ALARM SYSTEM BASED ON VIDEO ANALYSIS, filed 6 Feb. 2002 which is incorporated herein by reference. As mentioned the video signal capturing & storing component 20 recording is triggered selectively using face recognition for example recording pre-defined customers such as VIP customers, or only customers that their pictures are already stored in organization database 19 or any type of recording (total/selective) according to the service provider preferences. Preferably any pre-determine content of video can be used to identify start/stop the recording of frontal interaction. Coverage of video content analysis is described in details in co-pending US patent application titled: VIDEO AND AUDIO CONTENT ANALYSIS SYSTEM, Ser. No. 10/056,049 dated Jan. 30, 2001 stating the real-time capabilities based on video content analysis done using Digital Signal Processing (DSP/s) which is incorporated herein by reference. (d) The use of ROD (Record On Demand) is another solution for determining, or in this particular case manually controlling the start and end of interaction/recording. With ROD the agent can start and stop recording according based on his needs. For example whenever a deal is taking place he will record it for compliance needs, but he will not record when the customer only came to ask a question. The actual trigger of the recording can either be performed by a physical switch connecting and disconnecting the microphones from the capture device or by a software application running on the agent's computation device. (e) Total Recording is a straightforward solution to mean, record and store all calls during working hours of the service center, preferably if work force management system exist on site it can be integrated as to provide all agent's working periods and brake offs. NICE SYSTEMS Ltd. integration with Blue Pumpkin Software Inc. of Sunnyvale Calif. is a non-limiting example of using working hours information to calibrate scheduled based recording. (f) API Level integration with host applications in the computing system is another example of providing control capabilities on when start and end recording is set. Several capabilities can be achieved setting start and stop API commands, setting routing calls command and the like. Non-limiting example is the provider of CRM, Siebel Systems, Inc. of San Mateo, Calif., certified Integration with NICE SYSTEMS that consequently provided recording capabilities embedded within Siebel's Customer Relationship Management solution applications. Using ActiveX components or other means of command delivery, information can be inserted into the scripts of any host application the agent uses it in order that when he begins handling the customer the recording is started and when the handling ends it is stopped. (g) Integration with Queue Management Systems is a genuine solution for triggering and automatically controlling the start and stop recording. Queue management systems commonly control the flow of customer through walk-in environments. By integrating with such systems one can know when a new customer is assigned to an agent and the agent's position. Hence, by integrating with the queue management system we can understand when the interaction begins and if next one in queue deduces that previous interaction has ended. By deducting this we can trigger start and stop recording based on the status the queue management system holds for the agent. An example of a Queue Management System would be solutions (hardware and software) by Q-MATIC Corporation of Neongatan 8 S-43153 Molndal Sweden. It will be evident to the person skilled in the art that any combination of the above options (a) to (g) is contemplated by the present invention.

In addition, recording of silence can be avoided using either VOX activity detection for determine microphones activity or by using, later discussed in detail, video content to detect customer present in the (ROI) Region Of Interest covered by camera or either using screen and computer information to determine agent activity for example whether agent the is logged off, and the like scenarios. The different algorithms are parts of the respective components 17, 18, 20 constituting the interaction capture and storage units 15. Agents can also avoid recording if they turn off their microphones when they are not working.

Determining the beginning and end of the interaction was described in details in the previous paragraph. Now to the second obstacle, namely the problem of generating the metadata for describing the interactions entry in the database of recorded interactions, for the purpose of enabling fast query on the location of a specific interaction as well as to drive recording or interaction flagging decisions and for further analysis purposes. Metadata collection is one of the major challenges in Walk-in face-face-face recording environments characterized by the lack of the CTI or CDR/SMDR feed. This is limiting not only because it is needed to separate the interactions, previously discussed, but also because the data describing the call is required for other uses. This data, referred to as metadata can include the agents name or specific ID, the customer name or specific ID, an account number, the department or service the interaction is related to, various flags such as if a transaction was completed in the interaction or if the case has been closed, in addition to the beginning and end time of the interaction. This is the type of information one usually receives from the CTI link in telephony centric interaction but it is not available in this kind of frontal interaction based environment due to the fact that an interaction-enabling platform, such as telephony switch, is not required. As mentioned the metadata is typically used for defining the beginning and end of the interaction. It is also used for providing additional data to describe the interactions entry in the database of recorded interactions to enable fast location of a specific interaction. And, finally to drive recording decisions and flagging of interactions based on this data. An example for recording decisions are random or rule-based selection of interactions to be recorded or flagged for the purposes of quality management. A typical selection rule could be two interactions per agent per week, or one customer service interaction and one sales interaction per agent per day and one interaction per visiting customer per month. As the start and end of interaction was described in detail in the previous paragraph, the remaining metadata gathering of interaction's related information is accomplished using the following methods. (a) By logging the agent network login for example Novell or Microsoft login or supplying the agent an application to log-into the system, it is possible to ascertain which agent is using the specific position recorded on a specific channel and thus associate the agent name with the recording. (b) Again, as before capturing data on the agent's screen or from an application running on the computing device, either by integrating API commands and controls into the scripts of the application or by using screen analysis as shown in PCT co-pending patent application serial number PCT/IL02/00197 titled A METHOD FOR CAPTURING, ANALYZING AND RECORDING THE CUSTOMER SERVICE REPRESENTATIVE ACTIVITIES filed Mar. 12, 2002 and in PCT co-pending patent application serial number PCT/IL02/00796 titled SYSTEM AND METHOD FOR CAPTURING BROWSER SESSIONS AND USER ACTIONS filed Aug. 24, 2001 both are incorporated herein by reference. When provided in real time this can be used for real-time triggering of recording based on the data provided but more important it may be used to extract metadata from an existing application and store it in the database component 19. (c) By adding a DTMF generator and a keypad to the microphone mixer and/or amplifier enabling the agent or customer, to key-in information to be associated with the call such as customer ID or commands such as start or stop recording and the like. The DTMF detection function, which is a known in the art algorithm and typically exists in digital voice loggers is then used for recognizing the DTMF digits generated command or data and then the command is either executed or data is stored and related to the recording as metadata.

In addition, the system may be coupled and share resources with a traditional telephony environment recording and quality management solution for example: NiceLog, NiceCLS and NiceUniverse by NICE Systems Ltd. of Raanana, Israel. In such an implantation where two recording solutions co-exists part of the recording resources for voice and screen are allocated for recording of phone lines part for frontal face-to-face capturing device recording and events and additional information for these lines, are gathered through CTI integration. In such an environment one can then recreate all interactions related to a specific data element such as all interactions both phone and frontal of a specific customer. This can include, for example, the check-in and checkout of a hotel guest in conjunction with his calls to the room service line.

Due to the fact that frontal interaction may take place in environments with relatively high levels of noise there is a need to address the issue of audio quality and to provide improvement of the audio quality. In some environments simply using a multi-directional microphone will be sufficient. However, in environments with significant levels of ambient noise and interferences from neighboring positions a solution must be given to enable a reasonable level of understandability of the recorded voice. Solutions can be divided into three kinds: (1) Solutions external to the capture and recording apparatus, these kind of solutions include solutions for ambient noise reduction that are known in the art and use specialized microphones or microphone arrays with noise canceling functions. (2) Solutions within the capture and recording apparatus, which include noise reduction functions, performed in the capture and logging platform either during playback or during preprocessing of the input signal as shown in co-pending PCT patent application serial number PCT/IL02/00593 titled METHOD, APPARATUS AND SYSTEM FOR CAPTURING AND ANALYZING INTERACTION BASED CONTENT filed Jul. 18, 2002 incorporated herein by reference. Furthermore, as part of the audio classification process in the preprocessing stage described in detailed in this co-pending PCT patent application FIG. 4, filtering of background elements such as music, keyboards clicks and the like is discussed. (3) Another solution uses both (1) and (2) solutions from above—the external and the internal noise reduction. It offers a split between capture and recording apparatus and the environment external to this apparatus. This would include any combination of solutions presented in (1) and (2) for example a solution in which two directional microphones are pointed towards the customer and agent respectively, their signal enter the capture and logging platform where the sound common to both is detected and negated from both signals. Then both signals are mixed and recorded. They can also remain separated and be mixed only upon recreation of the voice-playback. Another example of a solution like this is one in which the two microphones are mixed/summed electronically using an electronic audio mixer and enter the capture and logging platform. In addition, an ambient signal is received by an additional multi-directional microphone located in the environment and enters the capture and logging platform. In the capture & logging platform the ambient noise is negated from the mixed agent/customer signal before recording or during playback.

In some instances it is beneficial to record video in the walk-in environment non-limiting examples of the advantages of using synchronized video recording on site were mentioned before as part of the solutions for determining start and end of interaction and for visually identifying of parties. In cases in which a single video camera is positioned to record each service position the implementation of playback is straightforward, i.e. playing back the video stream recorded at the same time or with a certain fixed bias from the period defined as the beginning and end of the service interactions, determined as previously discussed in “frame presence detection”. Other optional implementation instances would include an implementation in which two cameras are used per position, directed at the agent and customer, respectively. In this case at the point of replay the user can determine which video stream should be replayed or alternatively, have both play in a split screen. Another implementation instance would be an environment in which a strict one-to-one or many-to-one relationship between cameras and positions does not exist. In such an environment the users playing back the recording selects which video source is played back with the voice and optionally screen recording. It should be noted that the video and voice are synchronized by continuously synchronizing the clocks of the video capture & storage system with the Voice and Screen capture platform using any time synchronization method non limiting example are NTP Network Time Protocol, IRIG-B or the like. In cases where one lacks camera per position, one camera can be redirected to an active station based on interaction presence indication. Meaning that in scenarios where fewer cameras than positions exist the camera can be adaptively redirected (using camera PTZ—Pan, Tilt, Zoom) to the active position. Note that cameras can be remotely controlled, same as in the case of multimedia remote recording vicinities.

The systems described above can operate in conjunction with all other elements and product applicable to traditional voice recording and quality management solution such as remote playback and monitoring capabilities non-limiting examples of such products are Executive Connect by NICE Systems Ltd. of Raanana, Israel. Agent eLearning solutions—such as KnowDev by Knowlagent Inc, Alpharetta, Ga. This invention method and system is advantageous over existing solutions in the sense that it provides a solution for quality management of frontal face-to-face service environments. This enables companies to enhance their quality and get more information on their customer's satisfaction and to propose quality management solutions to cover its branches, offering the diverse type of traditional recording solutions whether it is total, selective, ROD, screen event triggered recording and the like for frontal service environments, executive tools to enable remote access to monitor and listen to interaction in the frontal service environments and when couple this solution with traditional telephony solution, yield full coverage on customer experience for better analysis.

The person skilled in the art will appreciate that what has been shown is not limited to the description above. The person skilled in the art will appreciate that examples shown here above are in no way limiting and serve to better and adequately describe the present invention. Those skilled in the art to which this invention pertains will appreciate the many modifications and other embodiments of the invention. It will be apparent that the present invention is not limited to the specific embodiments disclosed and those modifications and other embodiments are intended to be included within the scope of the invention. Although specific terms are employed herein, they are used in a generic and descriptive sense only and not for purposes of limitation. Persons skilled in the art will appreciate that the present invention is not limited to what has been particularly shown and described hereinabove. Rather the scope of the present invention is defined only by the claims, which follow.

1. An apparatus for capturing, storing and retrieving face-to-face interactions in walk-in environments for the purpose of further analysis, the apparatus comprising: a device for capturing and storing at least one face to face interaction captured in the presence of the parties to the interaction and a database for storing data and metadata information associated with the face-to-face interaction captured.

2. The apparatus of claim 1 wherein the device for capturing the at least one face to face interaction includes a voice capture and storage component.

3. The apparatus of claim 1 wherein the device for capturing the at least one face to face interaction includes a screen capture and storage component.

4. The apparatus of claim 1 wherein the device for capturing the at least one face to face interaction includes a video capture and storage component.

5. The apparatus of claim 1 wherein the device for capturing the at least one face to face interaction includes a database for recording data, metadata associated with the said interaction.

6. The apparatus of claims 1-5 wherein the device for capturing the at least one face to face interaction comprises of separated capture and storage components interconnected using local area or wide area or wireless or an IP-based networks.

7. The apparatus of claims 1-6 wherein the interaction is a man-to-machine interaction in which content is passed or exchanged.

8. The apparatus of claims 1-6 wherein the at least one face to face interaction comprises any one of the following: microphone recorded audio interaction, video interaction, or computation device screen interaction.

9. The apparatus of claim 1 wherein the metadata information is information related to the face-to-face interaction wherein each interaction has associated metadata.

10. The apparatus of claim 1 wherein the metadata associated with the face-to-face interaction is gathered where the interaction is not enabled by a telephony or a messaging platform.

11. The apparatus of claim 1 further comprises a telephony recording or a quality management device.

12. A method for metadata gathering in walk-in environments, the method comprising:
determining the beginning and ending of an interaction associated with a face-to-face interaction;
enabling fast location of specific interactions or to derive recording decisions; or for
flagging of interactions based on said data.

13. The method of claim 12 further comprises the step of integrating a queue management system wherein the queue management system provides data used to trigger recording of frontal face-to-face interaction or is used as metadata describing the said interaction.

14. The method of claim 12 further comprises the step of integrating a work force management system wherein the data from work force management system is used to trigger recording of frontal face-to-face interaction or is used as metadata describing the said interaction.

15. The method of claim 12 further comprises the step of capturing screen events of an agent action or data entering wherein the agent action or the data entering is used to trigger recording of frontal face-to-face interaction or is used as metadata describing the said interaction.

16. The method of claim 12 further comprises the step of time synchronization and content analysis of at least two of video, voice and screen wherein the analysis results triggers or is used to trigger recording of frontal face-to-face interaction or is used as metadata describing the said interaction.

17. The method of claim 12 further comprises the step of integrating a host computer application wherein the application serves as the trigger for recording of frontal face-to-face interaction or is used as metadata describing the said interaction.

18. The method of claim 12 wherein the metadata associated with the face-to-face interaction is gathered where the interaction is not enabled by a telephony or a messaging platforms.
